(19) United States
(12) Patent Application Publication
(10) Pub. No.: US 2026/0371412 A1
(43) Pub. Date: Nov. 19, 2026

(54) COMMUNICATION DEVICE, NON-TRANSITORY COMPUTER-READABLE STORAGE MEDIUM STORING COMPUTER-READABLE INSTRUCTIONS FOR COMMUNICATION DEVICE, AND METHOD EXECUTED BY COMMUNICATION DEVICE

(71) Applicant: BROTHER KOGYO KABUSHIKI KAISHA, Nagoya (JP)

(72) Inventor: Hiroyuki HAYASHI, Nagoya (JP)

(21) Appl. No.: 19/278,142

(22) Filed: Jul. 23, 2025

(30) Foreign Application Priority Data
Jul. 30, 2024 (JP) 2024-123410

(51) Int. Cl. H04W 76/10; H04W 48/16; H04W 84/12

(52) U.S. Cl. CPC H04W 76/10; H04W 48/16; H04W 84/12

(57) ABSTRACT

A specific communication device may include a memory which stores first method information indicating one or more available methods and a controller. The controller is configured to send a search signal, receive a response signal from each of M communication devices, in which each of M response signals includes device identification information identifying a sender of the response signal and second method information indicating one or more methods available to the sender, cause a display of the specific communication device to display a selection screen for a user to select a target communication device, in which the selection screen has a display style in which N device identification information included in N response signals is recognizable among M device identification information included in the M response signals, and each of the N response signals includes the second method information corresponding to the first method information in the memory.

### REFERENCE TO RELATED APPLICATIONS

This application claims priority from Japanese Patent Application No. 2024-123410 filed on Jul. 30, 2024. The entire content of the priority application is incorporated herein by reference.

### BACKGROUND ART

A technique of displaying a plurality of methods for obtaining a bootstrapping key for executing Device Provisioning Protocol (DPP) and displaying support information according to one obtaining method selected from among the plurality of obtaining methods is known.

### SUMMARY

The present teachings provide a technique which allows a user to suitably select a target communication device with which a specific communication device is to establish a wireless connection.

A specific communication device disclosed herein may include a communication interface configured to execute wireless communication. The specific communication device may include a memory configured to store first method information indicating available one or more methods for establishing a wireless connection via the wireless interface between the specific communication device and an external device. The specific communication device may include a controller. The controller may be configured to send a search signal for searching another communication device existing around the specific communication device. The controller may be configured to receive a response signal responsive to the search signal from each of M communication devices. Each of M response signals includes device identification information identifying a sender communication device of the response signal and second method information indicating available one or more methods which are available to the sender communication device of the response signal, and M is an integer equal to or greater than 1. The controller may be configured to cause a display of the specific communication device to display a device selection screen for a user to select a target communication device with which the specific communication device is to establish a wireless connection. The device selection screen has a display style in which N device identification information included in N response signals is recognizable among M device identification information included in the M response signals, the N being an integer equal to or greater than 1 and equal to or less than M. Each of the N response signals includes the second method information corresponding to the first method information in the memory.

According to the above configuration, the specific communication device receives the response signal from each of the M communication devices and displays the device selection screen having the recognizable display style in which the N device identification information included in the N response signal(s) are recognizable among the M device identification information included in the M response signal(s). Here, the N response signal(s) are signal(s) which include the second method information corresponding to the first method information indicating one or more methods available to the specific communication device. Accordingly, the user can suitably select the target communication device with which the specific communication device is to establish a wireless connection from among the N communication device(s) identified by the N device identification information.

A non-transitory computer-readable storage medium storing computer-readable instructions for the above-described specific communication device and a method executed by the specific communication device are also novel and useful.

### BRIEF DESCRIPTION OF DRAWINGS

FIG. 1 is a configuration view of a communication system.

FIG. 2 is a sequence diagram.

FIG. 3 is a sequence diagram continued from FIG. 2.

FIG. 4 is an illustration for describing device selection screens.

### DESCRIPTION

### First Embodiment

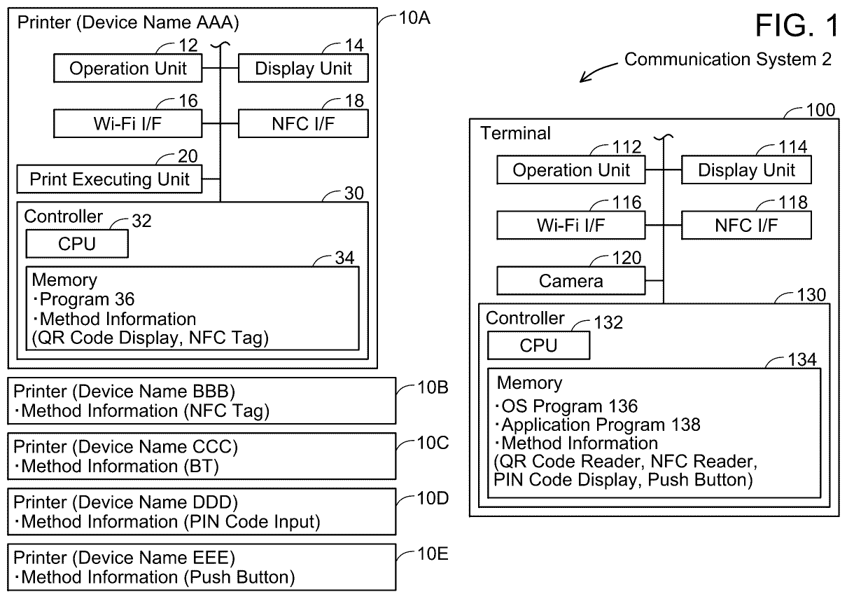

### Configuration of Communication System 2; FIG. 1

As shown in FIG. 1, a communication system 2 comprises a plurality of printers 10A t 10E and a terminal 100. In the present embodiment, a situation where a wireless connection according to Wi-Fi Aware scheme of a Wi-Fi standard (hereafter, “Wi-Fi Aware connection”) is established between the terminal 100 and one of the plurality of printers 10A to 10E will be assumed.

### Configuration of Printer 10A

The printer 10A is a peripheral device configured to execute a print function, e.g., a peripheral device for the terminal 100. In a modification, the printer 10A may be a multi-function peripheral configured to execute a scan function, a facsimile function in addition the print function. The printer 10A is assigned a device name “AAA” which is information identifying the printer 10A. The printer 10A comprises an operation unit 12, a display unit 14, a Wi-Fi interface 16, a Near Field Communication (NFC) interface 18, a print executing unit 20, and a controller 30. The respective units 12 to 30 are connected to a bus line. Hereafter, the interface will be referred to as “I/F”.

The operation unit 12 is a user interface which enables a user to input various information to the printer 10A. The operation unit 12 comprises for example a touch panel (touch screen) for displaying software key(s) (operation object(s)), hardware key(s), or both thereof. The hardware key(s) include, for example, button(s) and/or switch(es). The display unit 14 is a display or a panel for displaying various information. The panel may or may not be a touch panel (touch screen). Also, the panel is a liquid crystal panel or an organic EL panel. The print executing unit 20 comprises an inkjet print engine, an electrophotographic print engine, or a thermal print engine.

The Wi-Fi I/F 16 is a wireless I/F for wireless communication according to the Wi-Fi standard (termed “Wi-Fi communication” hereinafter). The Wi-Fi standard is a wireless communication standard for wireless communication according to, for example, 802.11 standard of the Institute of Electrical and Electronics Engineers, Inc. (IEEE) and standards in compliance therewith such as 802.11a, 11b, 11g, 11n, and 11ac. Especially, the Wi-Fi I/F 16 supports the Wi-Fi Aware scheme established by the Wi-Fi Alliance. The Wi-Fi Aware scheme is described in detail in the specification called “Wi-Fi Aware Specification Version 4.0” created by the Wi-Fi Alliance. Wi-Fi Aware is also called Wi-Fi Neighbor Awareness Network (NAN).

The devices (the printers 10A to 10E and the terminal 100) can join a NAN cluster of the Wi-Fi Aware scheme, although details will be described later. Among devices within the same NAN cluster, their Discovery Windows are synchronized. Here, a Discovery Window is a period during which signals are communicated.

The devices within the NAN cluster play any one of roles called Master, Anchor Master, and Non-Master. A Master is capable of sharing timer information, searching for services, and inviting a device to the NAN cluster. In addition to the Master's functions, an Anchor Master is also capable of setting timer information for synchronization. A Non-Master is capable of sharing timer information and searching for services but incapable of inviting a device to the cluster.

Each device within the NAN cluster can search for another device within the NAN cluster (more specifically, service which the other device provides). A signal for searching for a service is called ‘Subscribe’. The device having received the Subscribe sends a response signal called ‘Publish’. Although details will be described later, in the present embodiment, the terminal 100 sends the Subscribe for searching for another device which is capable of providing a connection service related to Wi-Fi Aware connection. Since the printer 10A is capable of providing the connection service, the printer 10A sends the Publish indicating that the printer 10A is capable of providing the connection service to the terminal 100. As a result of this, when a process for establishing Wi-Fi Aware connection between the printer 10A and the terminal 100 is executed, the Wi-Fi Aware connection is established.

The NFC I/F 18 is an I/F configured to execute wireless communication according to NFC scheme (hereafter termed “NFC” communication). The NFC scheme is a wireless communication scheme for so-called nearfield wireless communication, and is based on an international standard of ISO/IEC 21481 or 18092, for example.

Here, differences between the NFC communication and the Wi-Fi communication will be described. A communication speed of the Wi-Fi communication (with for example a maximum communication speed at 600 Mbps) is higher than a communication speed of the NFC communication (with for example a maximum communication speed at 424 Kbps). Frequencies of carrier waves in the Wi-Fi communication (e.g., 2.4 GHz band, 5.0 GHz band) are different from frequencies of carrier waves in the NFC communication (e.g., 13.56 MHz). A maximum distance over which the Wi-Fi communication is executable (e.g., 100 m) is greater than a maximum distance over which the NFC communication is executable (e.g., 10 cm).

The controller 30 comprises a CPU 32 and a memory 34. The memory 34 comprises a primary storage and an auxiliary storage. Although this is an example, the primary storage comprises a RAM and cache memory, for example. Although this is an example, the auxiliary storage comprises a ROM, a flash memory, a Solid State Drive (SSD), a Hard Disk Drive (HDD), or a combination thereof. The auxiliary storage of the memory 34 has a program 36 stored therein. The CPU 32 realizes various types of processes in accordance with the program 36 loaded from the auxiliary storage to the primary storage.

The memory 34 further stores method information indicating Bootstrapping method(s). Hereafter, Bootstrapping may be termed “BS”. BS is a process for a pair of devices to share a Service Set Identifier (SSID) and a password (hereafter termed “PW”). The SSID and the PW are used for executing Pre-Association Security Negotiation (PASN). The PASN is a process for a pair of devices to exchange key information such as a public key, and is executed similar to WPA3-SAE, for example.

The method information stored in the memory 34 of the printer 10A is information indicating one or more BS methods which the printer 10A supports (i.e., which are available to the printer 10A). Since the printer 10A supports two BS methods (i.e., QR Code Display, and NFC Tag), the memory 34 stores method information indicating these two methods. The BS method “QR Code Display” means that the device (e.g., printer 10A) is capable of displaying QR Code which can be obtained by cording the above-mentioned SSID and PW. Here, QR Code is a registered trademark of Denso Wave Incorporated. The BS method “NFC tag” means that the device (e.g., printer 10A) is capable of sending the above-mentioned SSID and PW to another device by NFC communication.

The printers 10B to 10E have the same configurations as the printer 10A except for the respective device names and that the method information stored in the memory differs from that of the printer 10A.

The printer 10B is assigned a device name “BBB”. The method information stored in the printer 10B indicates one BS method (i.e., NFC tag).

The printer 10C is assigned a device name “CCC”. The method information stored in the printer 10C indicates one BS method (i.e., Bluetooth (BT)). Here, Bluetooth is a registered trademark of Bluetooth SIG. The printer 10C comprises a BT I/F (not shown) configured to execute wireless communication according to a Bluetooth standard (hereafter termed “BT communication”). The BS method “BT” means that the device (e.g., printer 10C) is capable of sending the above-mentioned SSID and PW to another device by BT communication.

The printer 10D is assigned a device name “DDD”. The method information stored in the printer 10D indicates one BS method (i.e., PIN Code Input). The BS method “PIN Code Input” means that, when a PIN code is sent from the printer 10D to another device and also the PIN code displayed on the other device is inputted into the printer 10D, the printer 10D is capable of sending the above-mentioned SSID and PW to the other device.

The printer 10E is assigned a device name “EEE”. The method information stored in the printer 10E indicates one BS method (i.e., Push Button). The BS method “Push Button” means that, when a push button is operated at another device and also a push button of the printer 10E is operated, the printer 10E is capable of sending the above-mentioned SSID and PW to the other device.

### Configuration of Terminal 100

The terminal 100 is a mobile terminal device such as a cell phone, a smartphone, a PDA, a tablet PC. In a modification, the terminal 100 may be a stationary PC, a laptop PC, for example. The terminal 100 comprises an operation unit 112, a display unit 114, a Wi-Fi I/F 116, an NFC I/F 118, a camera 120, and a controller 130. The respective units 112 to 130 are connected to a bus line.

The operation unit 112 is a user interface which allows the user to input various information to the terminal 100. The operation unit 112 comprises a touch panel (touch screen) for displaying software key(s), hardware key(s), or both of them. The hardware key(s) comprise, for example, button(s) and/or switch(es). The display unit 114 is a display or a panel configured to display various information. The panel may or may not be a touch panel (touch screen). The panel is for example a liquid crystal panel or an organic EL panel. The Wi-Fi I/F 116 is the same as the Wi-Fi I/F 16 of the printer 10A. That is, the Wi-Fi I/F 116 supports Wi-Fi Aware scheme. The NFC I/F 118 is the same as the NFC I/F 18 of the printer 10A. The camera 120 is a device configured to capture an object. In the present embodiment, the camera 120 is used for capturing QR Code.

The controller 130 comprises a CPU 132 and a memory 134. The memory 134 comprises a primary storage and an auxiliary storage. Although this is an example, the primary storage comprises a RAM and cache memory. Although this is an example, the auxiliary storage may be, for example, a ROM, a flash memory, an SSD, an HDD, or any combination thereof. An OS program 136 and an application program 138 are stored in the auxiliary storage of the memory 134. Hereinafter, an OS program is abbreviated as “OS” and the application program is abbreviated as “app”.

The OS 136 controls basic operations of the terminal 100. Although this is an example the app 138 can cause the OS 136 to execute a process according to the Wi-Fi Aware scheme to establish Wi-Fi Aware connection between the printer 10A, etc. and the terminal 100. Also, the app 138 can send print data representing an image to be printed to the printer 10A, etc. by using such Wi-Fi Aware connection. The app 138 is downloaded, for example, from a server on the internet and installed in the terminal 100. That is, the app 138 is a so-called native application. The CPU 132 implements various processes according to the programs 136, 138 loaded from the auxiliary storage to the primary storage. Hereafter, respective processes implemented by the CPU 132 according to a program may be described as if the OS 136 or the app 138 subjectively implements such process.

The memory 134 further stores method information indicating one or more BS methods which the terminal 100 supports. Because the terminal 100 supports four BS methods (i.e., QR Code Reader, NFC Reader, PIN Code Display, and Push Button), the memory 134 stores the method information indicating these four methods.

The BS method “QR Code Reader” indicates that the device (e.g., the terminal 100) is capable of obtaining an SSID and a PW by capturing QR Code displayed on a printer and decoding the same. That is, the BS method “QR Code Reader” corresponds to the BS method “QR Code Display” of the printer 10A.

The BS method “NFC Reader” indicates that the device (e.g., the terminal 100) is capable of receiving the above-mentioned SSID and PW from a printer through NFC communication. That is, the BS method “NFC Reader” corresponds to the BS method “NFC Tag” of the printers 10A, 10B.

The BS method “PIN Code Display” indicates that the device (e.g., the terminal 100) capable of receiving a PIN code from a printer and displaying such PIN code. That is, the BS method “PIN Code Display” corresponds to the BS method “PIN Code Input” of the printer 10D.

The BS method “Push Button” means that, when a push button is operated at the terminal 100 and also a push button of a printer is operated, the terminal 100 is capable of receiving the above-mentioned SSID and PW from the printer. That is, the BS method “Push Button” corresponds to the BS method “Push Button” of the printer 10E.

Here, since the terminal 100 does not comprise a BT I/F, the terminal 100 is incapable of receiving the above-mentioned SSID and PW from a printer through BT communication. That is, the terminal 100 does not support a BS method corresponding to the BS method “BT” of the printer 10C.

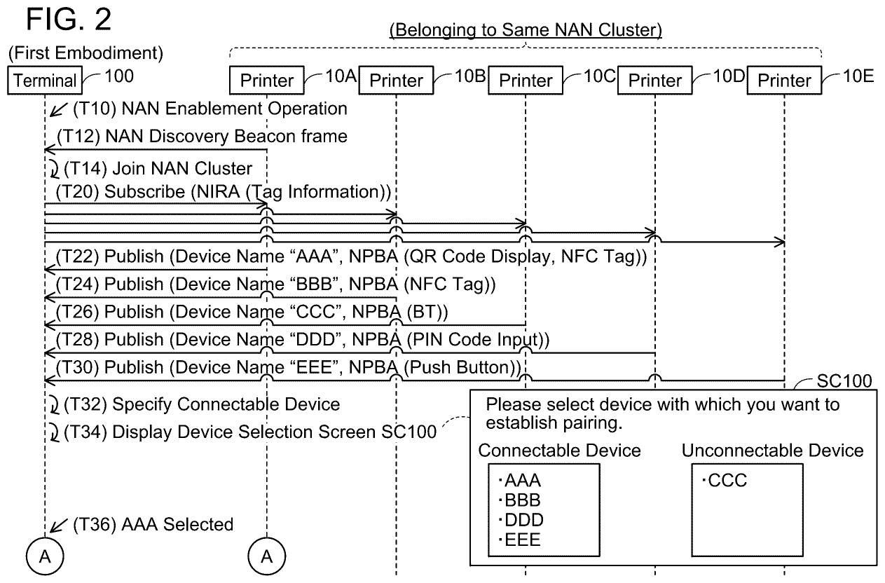

### Processes Executed Between Respective Devices; FIG. 2

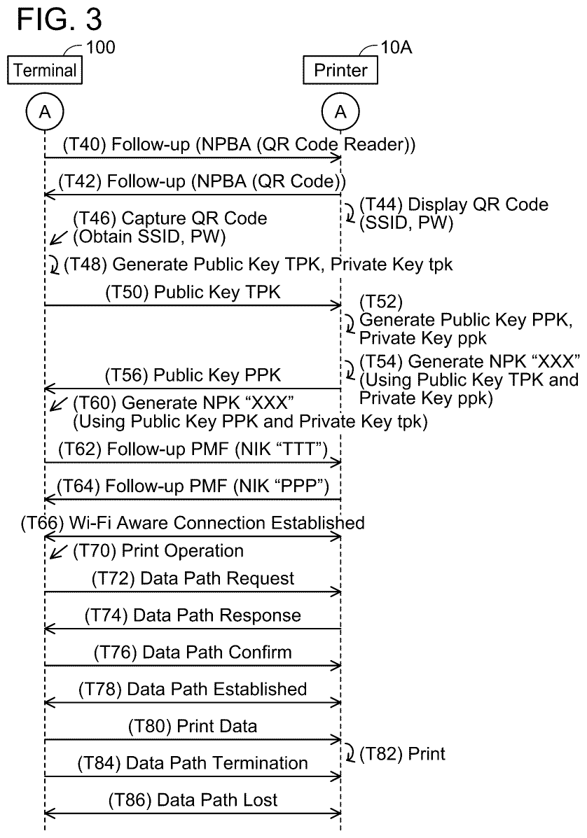

Referring now to FIGS. 2 and 3, steps performed between the devices will be described. Hereafter, in order to facilitate understanding, steps performed by the CPUs (e.g., 32, 132) of the device (e.g., the printers 10A to 10E, the terminal 100) are described as if devices perform the steps, instead of describing that the CPUs perform the steps. Every communication between the devices is executed via the Wi-Fi I/Fs (e.g., 16, 116). Thus, hereinafter, a phrase “via the Wi-Fi I/F” will be omitted in communication-related description.

At an initial state of FIG. 2, the printers 10A to 10E belong to a same NAN cluster. In such NAN cluster, the printer 10A operates as an Anchor Master. In particular, the printer 10A stores a Nan Identity Key (NIK) “PPP” of the printer 10A. NIK is device identification information in the Wi-Fi Aware scheme, and is information used for establishing Wi-Fi Aware connection. The other printers 10B to 10E operate as a Master for the NAN cluster. Each of the printers 10A to 10E and the terminal 100 have not executed pairing therebetween. That is, Wi-Fi Aware connection is not established between each of the printers 10A to 10E and the terminal 100.

The user wishes to have Wi-Fi Aware connection established with one or more of the printers. Accordingly, in T10, the terminal 100 receives a NAN enablement operation from the user. In this case, the terminal 100 shifts to a state of being able to receive a signal according to the Wi-Fi Aware scheme, and generates an NIK “TTT” of the terminal 100. Here, the “state of being able to receive a signal according to the Wi-Fi Aware scheme” means that the Wi-Fi I/F 116 can receive signals according to the Wi-Fi Aware scheme from external devices and the CPU 132 can perform steps according to the received signal.

In T12, the printer 10A sends a NAN Discovery Beacon frame (termed “Discovery” hereinafter) by broadcasting. The Discovery is a signal according to the Wi-Fi Aware scheme that advises information related to the NAN cluster to which the printer 10 belongs to external devices. Device(s) that do not belong to the NAN cluster can join the NAN cluster by receiving the Discovery. That is, the Discovery can be also construed as a signal for inviting device(s) that do not belong to the NAN cluster to the NAN cluster. The printer 10A periodically sends a Discovery. Although this is not illustrated, the respective printers 10B to 10E other than the printer 10A may also periodically send a Discovery.

At the time of T12, the terminal 100 is in the state of being able to receive signals according to the Wi-Fi Aware scheme. Thus, the terminal 100 receives the Discovery from the printer 10A in T12. In response, the terminal 100 joins the NAN cluster in T14. As a result, the printers 10A to 10E and the terminal 100 belong to the same NAN cluster. Although not illustrated, after joining the NAN cluster, the terminal 100 communicates with the printer 10A to determine its role in the NAN cluster. In the present case, the terminal 100 operates as a Non-Master.

In T20, the terminal 100 sends the Subscribe to the NAN cluster by broadcasting. The Subscribe is sent when a predetermined trigger (e.g., new participation in a NAN cluster, arrival of a predetermined timing, acceptance of a predetermined operation) occurs. In the present case, this Subscribe is sent to each the printers 10A to 10E within the NAN cluster. This Subscribe of the present case is a signal for searching a device which provides a connection service, i.e., a signal for searching a device being able to establish the Wi-Fi Aware connection. This Subscribe includes ‘NAN Identity Resolution Attribute (NIRA)’. Also, NIRA includes Tag information. The Tag information includes a hash value for the NIK “TTT” of the terminal 100. Here, although not described in particular in the present embodiment, the printer 10A, etc. may send a Subscribe.

When the printer 10A receives the Subscribe from the terminal 100 in T20, the printer 10A determines whether the printer 10A has executed the pairing with the sender terminal 100. Specifically, the printer 10A has a NIK of a device with which the printer 10A has executed pairing stored therein. The printer 10A specifies one stored NIK and calculates its hash value for the one NIK. When the calculated hash value and the hash value received in T20 match, the printer 10A determines that the printer 10A has executed pairing with the terminal 100. Contrary to this, when the calculated hash value and the hash value received in T20 do not match, the printer 10A specifies another stored NIK, and executes the same process for this other NIK. When the hash value of the NIK and the hash value stored in T20 do not match for all the stored NIKs, the printer 10A determines that the printer 10A has not executed pairing with the terminal 100. Also, when the printer 10A has no NIK stored therein, the printer 10A determines that the printer 10A has not executed the pairing with the terminal 100.

In the present case, the printer 10A determines that the printer 10A has not executed the pairing with the terminal 100, and in T22 the printer 10A sends a Publish including a device name “AAA” of the printer 10A itself and NAN Pairing Bootstrapping Attribute (NPBA) to the terminal 100. The NPBA includes method information stored in the memory 34 of the printer 10A (i.e., “Qr Code Display”, “NFC Tag”).

Also, when each of the printers 10B to 10E receives Subscribe from the terminal 100 in T20, the printer determines that the printer has not executed pairing with the terminal 100, and in each of T24 to T30, the respective printer sends a Publish to the terminal 100. The respective Publish includes the device name of the sender printer and NPBA including method information stored in the sender printer.

When the terminal 100 receives the Publish from each pf the printers 10A to 10E in T22 to T30, the terminal 100 specifies connectable device(s) with which the terminal 100 can connect in T32. Here the “connectable device(s)” mean one or more printers among the printers 10A to 10E with which the terminal 100 can execute BS. Specifically, the terminal 100 determines whether each received Publish includes BS method(s) corresponding to at least one BS method among the four BS methods indicated by the method information in the memory 134.

The terminal 100 specifies one BS method “QR Code Display” indicated by the method information included in NPBA in the Publish from the printer 10A. The method information in the memory 134 includes the BS method “QR Code Reader” corresponding to the specified BS method “QR Code Display”. The terminal 100 further specifies another BS method “NFC Tag” indicated by the method information included in the NPBA in the Publish from the printer 10A. The method information in the memory 134 includes the BS method “NFC Reader” corresponding to the specified BS method “NFC Tag”. Accordingly, the terminal 100 specifies the printer 10A as a connectable device.

By executing the same process as the above-described one for each of the other printers 10B to 10E, the terminal 100 determines whether each of the printers 10B to 10E is the connectable device. In the present case, the terminal 100 specifies the printers 10B, 10D, 10E as the connectable devices. This is because the BS methods “NFC Tag”, “PIN Code Input”, “Push Button” indicated by the method information included in the respective Publishes from the printers 10B, 10D, 10E correspond to the BS methods “NFC Reader”, “PIN Code Display”, “Push Button” included in the method information in the memory 134. On the other hand, the terminal 100 does not specify the printer 10C as the connectable device. That is, the terminal 100 specifies the printer 10C as an unconnectable device. This is because the BS method “BT” indicated by the method information included in the Publish from the printer 10C does not correspond to any of the BS methods indicated by the method information in the memory 134.

In T34, the terminal 100 displays a device selection screen SC100 on the display unit 114. The device selection screen SC100 includes a message which prompts the user to select a device and includes the device names “AAA” to “EEE” included in the respective Publishes. In particular, in the device selection screen SC100, the device name(s) of the connectable device(s) and the device name(s) of the unconnectable device(s) are displayed separately. The device names “AAA”, “BBB”, “DDD”, “EEE” of the connectable devices are indicated in a selectable display style. The device name “CCC” of the unconnectable device is indicated in an unselectable display style (e.g., display style of being grayed out). Thus, the unconnectable device can be suppressed from being mistakenly selected by the user. In the present case, the terminal 100 receives selection of the device name “AAA” of the connectable device from the user in T36.

Continuation from FIG. 2; FIG. 3

Firstly, the terminal 100 specifies, from among the four BS methods indicated by the method information in the memory 134, the BS method “QR Code Reader” corresponding to the BS method “QR Code Display” included in the method information in the Publish received from the printer 10A identified by the selected device name “AAA”. Next, in T40 in FIG. 3, the terminal 100 sends a Follow-up including the NPBA to the printer 10A. Such NPBA includes the specified BS method “QR Code Reader”. The Follow-up is a signal defined by the Wi-Fi Aware scheme. Here, as mentioned above, the method information in the memory 134 also includes the BS method “NFC Reader” corresponding to the BS method “NFC Tag” included in the method information in the Publish received from the printer 10A. Due to this, in a modification, the terminal 100 may send a Follow-up including the BS method “NFC Reader” to the printer 10A, instead of sending the BS method “QR Code Reader” in T40. As such, the terminal 100 simply needs to send a Follow-up which includes either of the BS method “QR Code Reader” or “NFC Reader” corresponding to the two BS methods “QR Code Display” and “NFC Tag” which the printer 10A supports, to the printer 10A. For example, the terminal 100 may specify one BS method which has a predetermined higher priority from among the two BS methods “QR Code Reader” and “NFC Reader”, or may randomly specify one BS method from among the above-mentioned two BS methods. Also, in another modification, the terminal 100 may send a Follow-up including the two BS methods to the printer 10A. In this case, which of the BS methods is to be used may be determined at the printer 10A.

When the printer 10A receives the Follow-up from the terminal 100 in T40,the printer 10A determines that the printer 10A is to execute BS by using QR Code based on the BS method “QR Code Reader” included in such Follow-up. Then, in T42, the printer 10A sends the Follow-up including NPBA to the terminal 100. Such NPBA includes information indicating execution of BS by using QR Code. Then, in T44 the printer 10A displays QR Code on the display unit 14. Such QR Code is a code image obtained by coding a SSID and a PW for executing PASN.

In T42, the terminal 100 receives the Follow-up from the printer 10A. In this case, although not illustrated, the terminal 100 may display on the display unit 114 a message notifying that QR Code displayed on the printer 10A should be captured. In T46, a user of the terminal 100 may capture the displayed QR Code on the printer 10A by using the camera 120 of the terminal 100. In this case, the terminal 100 obtains the SSID and PW by decoding the captured QR Code. The terminal 100 can execute PASN with the printer 10A by using the obtained SSID and PW.

Then, in T48 the terminal 100 generates a public key TPK and a private key tpk of the terminal 100. The public key TPK and the private key tpk are information used for generating NAN Pairing Key (NPK). The NPK is key information used for encryption in Wi-Fi Aware connection, and is information for establishing the Wi-Fi Aware connection. When the terminal 100 has generated the public key TPK and the private key tpk, in T50 the terminal 100 sends the public key TPK to the printer 10A.

When the printer 10A receives the public key TPK from the terminal 100 in T50, the printer 10A generates a public key PPK and a private key ppk of the printer 10A in T52. The public key PPK and the private key ppk are information used for generating NPK. When the printer 10A has generated the public key PPK and the private key ppk, the printer 10A generates NPK “XXX” by using the received public key TPK of the terminal 100 and the generated private key ppk of the printer 10A in T54. In T56, the printer 10A sends the public key PPK to the terminal 100.

When the terminal 100 receives the public key PPK from the printer 10A in T56, the terminal 100 generates the NPK “XXX” by using the received public key PPK of the printer 10A and the generated private key tpk of the terminal 100 in T60. The NPK “XXX” generated here and the NPK “XXX” generated by the printer 10A in T54 are the same. That is, the NPK “XXX” is shared between the printer 10A and the terminal 100.

Next, in T62, the terminal 100 sends ‘Follow-up Protected Management Frame (PMF)’ including the NIK “TTT” of the terminal 100 to the printer 10A. Here, the “Follow-up PMF” means executing Follow-up communication by using a communication path which is encrypted by NPK. That is, the Follow-up of T62 is sent from the terminal 100 to the printer 10A by using the communication path encrypted by the NPK “XXX”.

In T62, the printer 10A receives Follow-up PMF including the NIK “TTT” of the terminal 100 from the terminal 100. In T64, the printer 10A then sends Follow-up PMF including the NIK “PPP” of the printer 10A to the terminal 100.

In T64, the terminal 100 receives the Follow-up PMF including the NIK “PPP” of the printer 10A from the printer 10A. By the above processes, the printer 10A obtains the NPK “XXX” and the NIK “TTT” of the terminal 100. Also, the terminal 100 obtains the NPK “XXX” and the NIK “PPP” of the printer 10A. As mentioned above, an NPK and an NIK are information for establishing the Wi-Fi Aware connection. Accordingly, in T66, respective processes in which the NPK, NIK or the like are used are executed between the printer 10A and the terminal 100, and the Wi-Fi Aware connection is established between the printer 10A and the terminal 100 (i.e., the printer 10A and the terminal 100 enter a state of having executed the pairing).

Thereafter, in T70, the terminal 100 receives a print operation for causing the printer 10A to print an image to be printed from the user. Such print operation includes, for example, designation of image data representing the image to be printed, designation of a printer to be caused to print, and/or setting on print condition(s) (e.g., print paper size, number of sheets to be printed, number of colors (color, monochrome, grayscale)). In this case, in T72, the terminal 100 sends a Data Path Request to the printer 10A. The Data Path Request is a signal which requests the printer 10A to establish a communication path (i.e., Data Path) for communication of print data within the established Wi-Fi Aware connection (see T66).

When the printer 10A receives the Data Path Request from the terminal 100 in T72, the printer 10A sends a Data Path Response to the terminal 100 in T74.

When the terminal 100 receives the Data Path Response from the printer 10A in T74, the terminal 100 sends a Data Path Confirm to the printer 10A in T76. As a result of this, in T78 a Data Path is established within the Wi-Fi Aware connection between the printer 10A and the terminal 100. Then, in T80, the terminal 100 sends the print data representing the image to be printed by using the Data Path to the printer 10A. The print data has a data format which the printer 10A can interpret.

When the printer 10A receives the print data from the terminal 100 in T80, the printer 10A causes the print executing unit 20 to print the image to be printed represented by such image data in T82.

When the terminal 100 has completed sending the print data in T80, the terminal 100 sends a Data Path Termination to the printer 10A in T84. As a result of this, in T86 the Data Path between the printer 10A and the terminal 100 disappears.

### Effects by First Embodiment

According to the above configuration, the terminal 100 receives the Publishes respectively from the five printers 10A to 10E (T22 to T30 in FIG. 2), and displays the device selection screen SC100 having a recognizable display style in which the device names of the connectable devices “AAA”, “BBB”, “DDD”, “EEE” are recognizable (T34). Accordingly, the user can suitably select a printer with which the Wi-Fi Aware connection with the terminal 100 should be established from among the four printers 10A, 10B, 10D, 10E identified by the four device names “AAA”, “BBB”, “DDD”, “EEE”.

### Correspondence Relationships

The terminal 100 is an example for “specific communication device”. The printers 10A to 10E are an example for “M communication devices”. The printer 10A is an example for “target communication device”. The Wi-Fi I/F 116 is an example for “wireless interface”. The method information stored by the terminal 100 and the method information stored by each of the printers 10A to 10E are respectively an example for “first method information” and “second method information”. The Subscribe in T20 in FIG. 2 and the Publishes in T22 to T30 are respectively an example for “search signal” and “response signal”. The device name is an example for “device identification information”. In particular, the five device names “AAA” to “EEE”, the four device names “AAA”, “BBB”, “DDD”, “EEE”, the one device name “CCC” are respectively an example for “M device identification information”, “N device identification information”, “(M-N) device identification information. The device name “AAA” of the printer 10A is an example for “target device identification information”. The device selection screen SC100 is an example for “device selection screen”. The Wi-Fi Aware connection established in T66 in FIG. 3 is an example for “a wireless connection”. QR Code is an example for “code image”. The NFC communication and the BT communication are examples for “near field wireless communication”.

The process of T20 and the processes of T22 to T30 in FIG. 2 are an example for “send a search signal”, “receive a response signal”, respectively. The process of T34 is an example for “cause a display of the specific communication device to display a device selection screen”. The process of T66 in FIG. 3 is an example for “establish a wireless connection”.

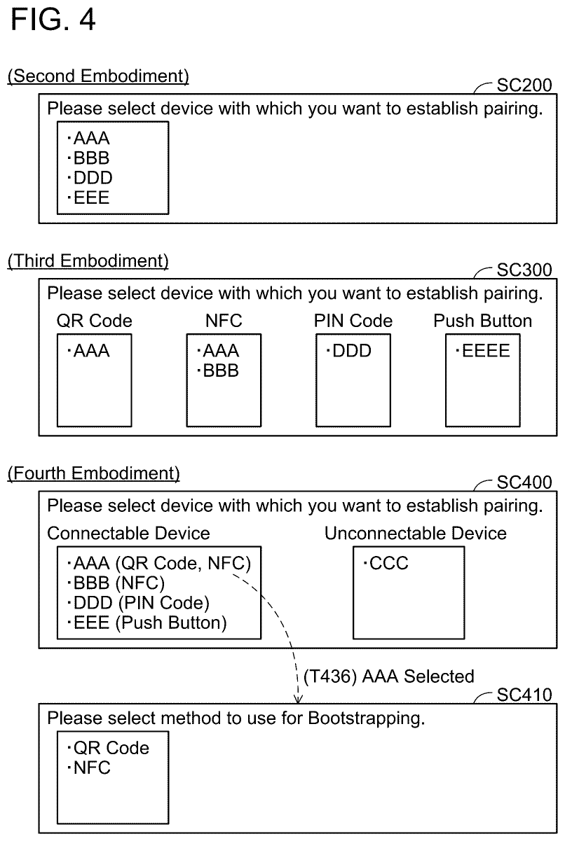

### Second Embodiment; FIG. 4

Subsequently, with reference to FIG. 4, a second embodiment will be described. In the second embodiment, instead of the device selection screen SC100, a device selection screen SC200 is displayed in T34 in FIG. 2. In the device selection screen SC200, the device name(s) of unconnectable device(s) are not displayed. In such form of the device selection screen SC200 also, the user can suitably select a printer with which the Wi-Fi Aware connection with the terminal 100 should be established from among the four printers 10A, 10B, 10D, 10E identified by the four device names “AAA”, “BBB”, “DDD”, “EEE”.

### Third Embodiment; FIG. 4

Subsequently, with reference to FIG. 4, a third embodiment will be described. In the third embodiment, instead of the device selection screen SC100, a device selection screen SC300 is displayed in T34 in FIG. 2. In the device selection screen SC300, for each of the four BS methods supported by the terminal 100, a character string corresponding to the BS method (e.g., “QR Code”, “NFC”) and the device name(s) of the printer(s) which support the BS method are displayed in association with each other. For example, since in the present embodiment, among the printers 10A to 10E, the printer 10A supports the BS method “QR Code Display”, in the device selection screen SC300, the device name “AAA” of the printer 10A is displayed in association with the character string “QR Code”. Similarly, since, among the printers 10A to 10E, the printers 10A, 10B support the BS method “NFC Tag”, in the device selection screen SC300, the device name “AAA” of the printer 10A and the device name “BBB” of the printer 10B are displayed in association with the character string “NFC”. In such form of the device selection screen SC300 also, the user can suitably select a printer with which the Wi-Fi Aware connection with the terminal 100 should be established from among the four printers 10A, 10B, 10D, 10E identified by the four device names “AAA”, “BBB”, “DDD”, “EEE”.

In particular, in the device selection screen SC300, the device name(s) such as each of the printer 10A, etc., are displayed in association with the character strings corresponding to the BS methods which each of the printer 10A, etc. supports. As such, by looking at the device selection screen SC300, the user can acknowledge which BS method each of the printer 10A, etc. supports.

Here, the printer 10A has stored the method information indicating the two BS methods “QR Code Display”, “NFC Tag” therein. Due to this, in the device selection screen SC300, the device name “AAA” is displayed in association with the character string “QR Code” and also the device name “AAA” is displayed in association with the character string “NFC”. When the device name “AAA” associated with the character string “QR Code” is selected by the user, the terminal 100 sends a Follow-up including the BS method “QR Code Reader” to the printer 10A in T40 in FIG. 3. Also when the device name “AAA” associated with the character string “NFC” is selected by the user, the terminal 100 sends a Follow-up including the BS method “NFC Reader” to the printer 10A in T40 in FIG. 3. Thus, the user can select which BS method to execute BS with the printer 10A.

In the present embodiment, each character string (e.g., “QR Code”, “NFC”) associated with the device name(s) in the device selection screen SC300 is an example for “method identification information”.

### Fourth Embodiment; FIG. 4

Subsequently, with reference to FIG. 4, a fourth embodiment will be described. In the fourth embodiment, instead of the device selection screen SC100, a device selection screen SC 400 is displayed in T34 in FIG. 2. In the device selection screen SC400, in association with each of the device names of the connectable devices, character string(s) indicating the BS method(s) supported by the device with the corresponding device name are displayed. In such form of the device selection screen SC400 also, the user can suitably select a printer with which the Wi-Fi Aware connection with the terminal 100 should be established from among the four printers 10A, 10B, 10D, 10E identified by the four device names “AAA”, “BBB”, “DDD”, “EEE”. Also, by looking at the device selection screen SC400, the user can acknowledge which BS method each of the printer 10A, etc. supports.

When the terminal 100 receives selection of the device name “AAA” associated with the two BS methods (i.e., “QR Code”, “NFC”) from the user in T436, the terminal 100 displays a method selection screen SC410 on the display unit 114. The method selection screen SC410 includes a message prompting the user to select a BS method and the above-mentioned two character strings (i.e., “QR Code”, “NFC”). The terminal 100 sends a Follow-up including the BS method selected on the method selection screen SC410 to the printer 10A in T40 in FIG. 3. As such, the user can select which BS method to execute the BS with the printer 10A on the method selection screen SC410.
(Modification 1) In each of the above embodiments, the terminal 100 searches for the printers 10A to 10E existing around the terminal 100, and displays the device selection screen SC100. Instead of this, for example, the printer 10A may search for the devices 10B to 10E, 100 existing around the printer 10A, and may display a device selection screen on the display unit 14 of the printer 10A. Then, when the printer 10A receives selection of the device name of the terminal 100, the printer 10A establishes Wi-Fi Aware connection with the terminal 100. In the present modification, the printer 10A is an example for “specific communication device”.
(Modification 2) In each of the above embodiments, each of the printers 10A to 10E sends the device name of the printer itself and the BS method(s) to the terminal 100 through the Publish. Instead of this, each of the printers 10A to 10E may use the Follow-up to send information such as the device name to the terminal 100. In the present modification, such Follow-up is an example for “response signal”.
(Modification 3) In the device selection screen SC100 in FIG. 2, the device name “CCC” of the unconnectable device may be indicated in the selectable display style.
(Modification 4) BS method(s) besides the above-mentioned BS methods are also possible. For example, a situation in which a printer supports a BS method “Passphrase Input” and another device (e.g., the terminal 100) supports a BS method “Passphrase Display” will be assumed. The BS method “Passphrase Input” means that, when a passphrase is sent from the printer to the other device and also the passphrase displayed on the other device is inputted to the printer, the printer is capable of sending the above-mentioned SSID and PW to the other device. The BS method “Passphrase Display” means that the other device is capable of receiving the passphrase from the printer and displaying the passphrase.
(Modification 5) In the device selection screen SC300, etc. in the third embodiment, instead of the character string(s) corresponding to the BS method(s), a symbol, a mark, an icon, for example, may be displayed. In the present modification, the symbol, the mark, the icon are an example for “method identification information”.
(Modification 6) The terminal 100 may use a search signal according to a different scheme different from the Wi-Fi Aware scheme to search for printer(s) existing around the terminal 100 in T20. Also, the terminal 100 may receive a response signal according to a scheme different from the Wi-Fi Aware scheme. Also, a wireless connection established between the printer 10A and the terminal 100 may not be Wi-Fi Aware connection (i.e., wireless connection according to the Wi-Fi Aware scheme).
(Modification 7) Although in each of the above embodiments the processes of the respective processes of FIGS. 2, 3 are realized by software (e.g., program 36, the OS 136, the app 138), at least one of these processes may be realized by hardware such as logic circuitry.

What is claimed is:

1. A specific communication device comprising:
a communication interface configured to execute wireless communication;
a memory configured to store first method information indicating one or more methods available for establishing a wireless connection via the wireless interface between the specific communication device and an external device; and
a controller configured to:
send a search signal for searching another communication device existing around the specific communication device;
receive a response signal responsive to the search signal from each of M communication devices, wherein each of M response signals includes device identification information identifying a sender communication device of the response signal and second method information indicating one or more methods which are available to the sender communication device of the response signal, and M is an integer equal to or greater than 1; and
cause a display of the specific communication device to display a device selection screen for a user to select a target communication device with which the specific communication device is to establish a wireless connection, wherein the device selection screen has a display style in which N device identification information included in N response signals is recognizable among M device identification information included in the M response signals, the N being an integer equal to or greater than 1 and equal to or less than M, and each of the N response signals includes the second method information corresponding to the first method information in the memory.

2. The specific communication device as in claim 1,
wherein the device selection screen includes the N device identification information in a selectable display style, and
the device selection screen does not include each of (M-N) device identification information included in (M-N) response signal, among the M device identification information included in the M response signals, as device identification information in a selectable display style.

3. The specific communication device as in claim 2,
wherein the device selection screen includes the (M-N) device identification information in an unselectable display style.

4. The specific communication device as in claim 2,
wherein the device selection screen does not include the (M-N) device identification information.

5. The specific communication device as in claim 1,
wherein the one or more methods include at least one of:
a method using a code image;
a method using near field wireless communication;
a method using a Personal Identification Number (PIN) code; and
a method using a push button.

6. The specific communication device as in claim 1,
wherein the device selection screen includes, for each of the N device identification information, method identification information corresponding to a method available to a communication device identified by the device identification information.

7. The specific communication device as in claim 1,
wherein the controller is further configured to:
in a case where target device identification information is selected from the N device identification information in the device selection screen, establish a wireless connection via the wireless interface between the specific communication device and the target communication device identified by the target device identification information.

8. The specific communication device as in claim 1,
wherein the wireless interface is a communication interface configured to execute wireless communication according to a Wi-Fi Aware scheme of a Wi-Fi standard,
each of the search signal and the response signal is a signal according to the Wi-Fi Aware scheme, and
the wireless connection is a wireless connection according to the Wi-Fi Aware scheme.

9. A non-transitory computer-readable storage medium storing computer-readable instructions for a specific communication device, the specific communication device comprising:
a communication interface configured to execute wireless communication;
a memory configured to store first method information indicating one or more methods available for establishing a wireless connection via the wireless interface between the specific communication device and an external device; and
a processor,
wherein the computer-readable instructions, when executed by the processor, cause the specific communication device to:
send a search signal for searching another communication device existing around the specific communication device;
receive a response signal responsive to the search signal from each of M communication devices, wherein each of M response signals includes device identification information identifying a sender communication device of the response signal and second method information indicating one or more methods which are available to the sender communication device of the response signal, and M is an integer equal to or greater than 1;
cause a display of the specific communication device to display a device selection screen for a user to select a target communication device with which the specific communication device is to establish a wireless connection, wherein the device selection screen has a display style in which N device identification information included in N response signals is recognizable among M device identification information included in the M response signals, the N being an integer equal to or greater than 1 and equal to or less than M, and each of the N response signals includes the second method information corresponding to the first method information in the memory.

10. A method executed by a specific communication device, the specific device comprising:
a communication interface configured to execute wireless communication; and
a memory configured to store first method information indicating one or more methods available for establishing a wireless connection via the wireless interface between the specific communication device and an external device,
wherein the method comprises:
sending a search signal for searching another communication device existing around the specific communication device;
receiving a response signal responsive to the search signal from each of M communication devices, wherein each of M response signals includes device identification information identifying a sender communication device of the response signal and second method information indicating one or more methods which are available to the sender communication device of the response signal, and M is an integer equal to or greater than 1;
causing a display of the specific communication device to display a device selection screen for a user to select a target communication device with which the specific communication device is to establish a wireless connection, wherein the device selection screen has a display style in which N device identification information included in N response signals is recognizable among M device identification information included in the M response signals, the N being an integer equal to or greater than 1 and equal to or less than M, and each of the N response signals includes the second method information corresponding to the first method information in the memory.
